(19) United States
(12) Patent Application Publication
(10) Pub. No.: US 2010/0136444 A1
(43) Pub. Date: Jun. 3, 2010

(54) Electrical bridge for fuel cell plates

(76) Inventor: David A. Nash, Paris, TN (US)

Correspondence Address: MARSHALL & MELHORN, LLC, FOUR SEAGATE, 8TH FLOOR, TOLEDO, OH, 43804, US

(21) Appl. No.: 11/231,476

(22) Filed: Sep. 21, 2005

(51) Int. Cl. H01M 8/24; H01M 8/02; H01M 8/04

(52) U.S. Cl. 429/428; 429/516; 429/471

(57) ABSTRACT

An electrical bridge is provided for a fuel cell plate which allows for electrical signals to pass in and out of the fuel cell without creating an additional leak path. The electrical bridge provides a mechanism for determining internal conditions of a fuel cell stack using external monitoring devices. The electrical bridge may also provide a mechanism for supplying power to internal sensing and control devices.

### FIELD

The present invention generally relates to fuel cells, and more particularly to a fuel cell assembly that includes an electrical interface.

### BACKGROUND

A fuel cell is a device that converts chemical energy of fuels directly to electrical energy and heat. In its simplest form, a fuel cell comprises two electrodes, i.e., an anode and a cathode, separated by an electrolyte. During operation, a gas distribution system supplies the anode and the cathode with fuel and an oxidizer, respectively. Typically, fuel cells use the oxygen in the air as the oxidizer and hydrogen gas (including H₂ produced by reforming hydrocarbons) as the fuel. Other viable fuels include reformulated gasoline, methanol, ethanol, and compressed natural gas, among others. The fuel undergoes oxidation at the anode, producing protons and electrons. The protons diffuse through the electrolyte to the cathode where they combine with oxygen and the electrons to produce water and heat. Because the electrolyte acts as a barrier to electron flow, the electrons travel from the anode to the cathode via an external circuit containing a motor or other electrical load that consumes power generated by the fuel cell.

Currently, there are at least five distinct fuel cell technologies, each based on a different electrolyte. One class of fuel cells, which is known as a polymer electrolyte membrane (PEM) fuel cell, appears well-suited for mobile power generation (transportation applications) because of its relatively low operating temperatures (about 60° C. to about 100° C.) and its relatively quick start up. PEM fuel cells use an electrolyte composed of a solid organic polymer, which is typically a poly-perfluorosulfonic acid. Other fuel cell technologies include electrolytes comprised of solid zirconium oxide and ytrria (solid oxide fuel cells) or a solid matrix saturated with a liquid electrolyte. Liquid electrolytes include aqueous potassium hydroxide (alkaline fuel cells), phosphoric acid (phosphoric acid fuel cells), and a mixture of lithium, sodium, and/or potassium carbonates (molten carbonate fuel cells). Although phosphoric acid fuel cells (PAFC) operate at higher temperatures than PEM fuel cells (about 175° C. to about 200° C.), PAFCs also find use in vehicle applications because of their higher efficiency and their ability to use impure hydrogen gas as fuel.

The core of a typical PEM fuel cell is a three-layer membrane electrolyte assembly (MEA). The MEA is comprised of a sheet of the polymeric electrolyte, which is about 50μ to about 175μ thick and is sandwiched between relatively thin porous electrodes (anode and cathode). Each of the electrodes usually consists of porous carbon bonded to platinum particles, which catalyze the dissociation of hydrogen molecules to protons and electrons at the anode and the reduction of oxygen to water at the cathode. Both electrodes are porous and therefore permit gases (fuel and oxidizer) to contact the catalyst. In addition, platinum and carbon conduct electrons well so that electrons move freely throughout the electrodes.

An individual fuel cell generally includes backing layers that are placed against the outer surfaces of the anode and the cathode layers of the MEA. The backing layers allow electrons to move freely into and out of the electrode layers, and therefore are often made of electrically conductive carbon paper or carbon cloth, usually about 100μ to 300μ thick. Since the backing layers are porous, they allow fuel gas or oxidizer to uniformly diffuse into the anode and cathode layers, respectively. The backing layers also assist in water management by regulating the amount of water vapor entering the MEA with the fuel and oxidizer and by channeling liquid water produced at the cathode out of the fuel cell.

A complete fuel cell includes a pair of plates pressed against the outer surfaces of the backing layers. Besides providing mechanical support, the plates define fluid flow paths within the fuel cell, and collect current generated by oxidation and reduction of the chemical reactants. The plates are gas-impermeable and have channels or grooves formed on one or both surfaces facing the backing layers. The channels distribute fluids (gases and liquids) entering and leaving the fuel cell, including fuel, oxidizer, water, and any coolants or heat transfer liquids. As discussed below, each plate may also have one or more apertures extending through the plate that distribute fuel, oxidizer, water, coolant and any other fluids throughout a series of fuel cells. Each plate is made of an electron conducting material including graphite, aluminum or other metals, and composite materials such as graphite particles imbedded in a thermosetting or thermoplastic polymer matrix.

For most applications, individual fuel cells are connected in series or are “stacked” to form a fuel cell assembly. A single fuel cell typically generates an electrical potential of about one volt or less. Since most applications require much higher voltages—for example, conventional electric motors normally operate at voltages ranging from about 200 V to about 300 V—individual fuel cells are stacked in series to achieve the requisite voltage. To decrease the volume and mass of the fuel cell assembly, a single plate separates adjacent fuel cells in the stack. Such plates, which are known as bipolar plates, have fluid flow channels formed on both major surfaces—one side of the plate may carry fuel, while the other side may carry oxidizer.

Because the fluids flowing within a particular fuel cell and between adjacent fuel cells must be kept separate, conventional fuel cell assemblies employ resilient o-rings or planar inserts disposed between adjacent fuel cell plates to seal flow channels and apertures. In addition, conventional fuel cell assemblies also provide electrical insulating sheets between adjacent plates to prevent individual fuel cells from short-circuiting. Once a fuel cell assembly has been constructed, it is important that the integrity of the fluid seals and insulating barriers remain intact such that the assembly continues to operate at optimum efficiency. However, there are circumstances where it may be desirable to tap into the fuel cell for the purpose of determining the status of certain internal conditions of the fuel cell, e.g., electrical parameters, temperature, and pressures. Information relative to these internal conditions can be useful in the development of more efficient fuel cells. It is appreciated that such internal conditions may be determined by monitoring electrical signals at electrical contacts in communication with the internal environment of the fuel cell or by communicating with sensing devices disposed within the fuel cell. Such monitoring would require an electrical bridge or conductive path whereby the electrical signals can pass in and out of the fuel cell while not allowing fluids and gases therein to leak out. Unfortunately, existing fuel cell assemblies do not provide a means for introducing an electrical bridge into a fuel cell without creating a potential leak path.

### SUMMARY

The present invention provides an electrical bridge for a fuel cell plate which allows for electrical signals to pass in and out of the fuel cell without creating an additional leak path. The electrical bridge provides a mechanism for determining internal conditions of a fuel cell stack, such as temperature, pressure, electrical flow, or other parameters, by using sensing devices and external monitors.

As an advantage over conventional fuel cells, an embodiment of the present invention provides a fuel cell assembly including at least one fuel cell plate having at least one electrical bridge. The electrical bridge includes at least one electrical terminal having a first portion extending within the fuel cell plate and a second portion external to the fuel cell plate.

In one embodiment, a non-conductive fluid seal material is disposed around at least a portion of the electrical terminal such that leakage of fluid and gases from within the fuel cell is prevented. The internal portion of the sealed electrical terminal may be configured to communicate with at least one channel or aperture formed in the fuel cell plate while the external portion may be configured to be selectively connectable to a monitoring device or power supply.

### BRIEF DESCRIPTION OF THE DRAWINGS

The accompanying drawings illustrate embodiments of the present invention and are a part of the specification. The illustrated embodiments are merely exemplary of the invention and do not limit the scope of the invention. Throughout the drawings, identical reference numbers designate identical or similar elements. In the drawings:

FIG. 1 is a perspective view of an embodiment of a fuel cell assembly including a plurality of electrical bridges;

FIG. 2 is an elevational view of the an embodiment of a fuel cell plate including an electrical bridge;

FIG. 3 is an enlarged and fragmented top view of an electrical bridge; and

FIGS. 4A-4B illustrate an alternative embodiment of a fuel cell plate.

### DETAILED DESCRIPTION

Although described in relation to a PEM fuel cell assembly, the disclosed electrical bridge can be used to provide a mechanism for allowing electrical signals to be passed in and out of a fuel cell assembly without creating a leak path. For example, the embodiments of the electrical bridge described herein may be used in solid oxide fuel cells, alkaline fuel cells, phosphoric acid fuel cells, and molten carbonate fuel cells.

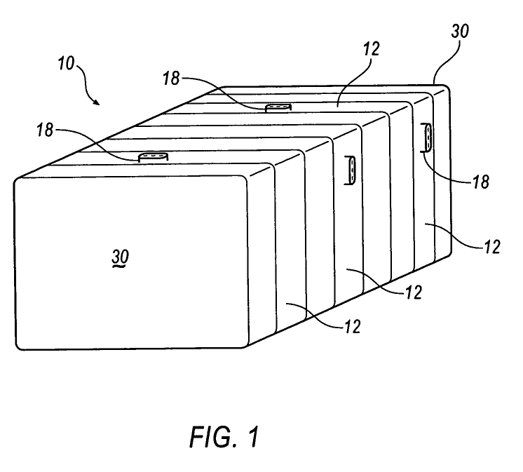

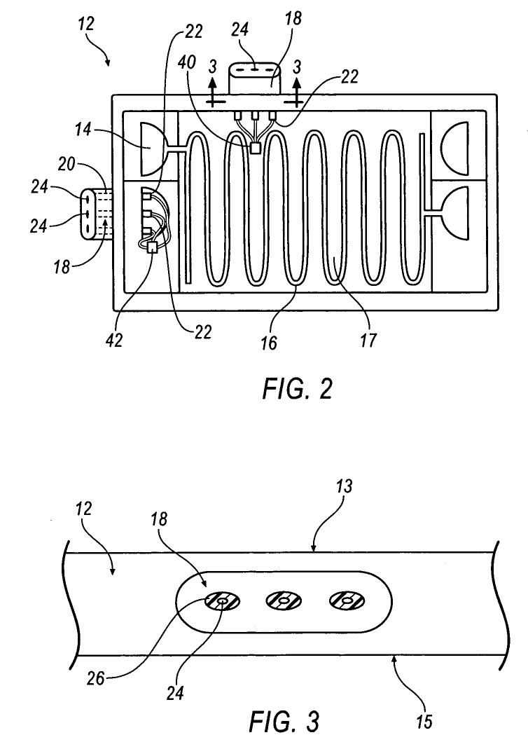

FIG. 1 is a perspective view of an embodiment of a fuel cell assembly 10. Fuel cell assembly 10 includes a plurality of fuel cell plates 12 that are arranged in series and stacked together with end plates 30. As illustrated in FIG. 2, each fuel cell plate 12 includes apertures and fluid flow paths 14, 16, respectively, within the fuel cell assembly 10 and at least one electrical bridge 18. The apertures 14 extend between first 13 and second 15 major surfaces of the plates 12 (as best seen in FIG. 3). When the plates 12 are stacked to produce the fuel cell assembly 10, the apertures 14 of adjacent plates 12 align, forming cavities that extend throughout the fuel cell assembly 10. At least one of the major surfaces 13, 15 of each fuel cell plate 12 may also include major surfaces 17 that define recessed flow paths 16 when the plates 12 are stacked together to form the assembly 10.

Some of the cavities and/or flow paths 16 deliver fluids (fuel, oxidizer) to individual fuel cells, or deliver fluids (coolant, heat transfer fluid) to cooling areas between individual fuel cells 12. Other cavities and/or flow paths 16 serve as collection regions for fluids (reaction products, coolant, heat transfer fluid).

During operation, fuel, oxidizer, coolant, and reaction products enter and leave the cavities through fluid connections (not shown) located on the end plates 30 as best illustrated in FIG. 1. As noted above, the fuel cell plates 12 may also have flow paths 16 formed on either or both of the first 13 and second 15 major surfaces, and evenly distribute reactants or heat transfer fluid across an active portion and/or a cooling area of each of the fuel cells 12.

As can be seen in FIGS. 1-3, the plates 12 include at least one electrical bridge 18 that provides a mechanism for determining certain internal conditions of a fuel cell assembly 10. For example, the electrical bridge 18 may be used in combination with an external monitoring device (not shown) for determining the internal temperature of the coolant fluid, or for determining electrical parameters being produced by the fuel cell. Referring to FIG. 2, the electrical bridge 18 includes at least one electrical terminal 20. Each electrical terminal 20 has a first portion 22 extending within the fuel cell plate 12 and a second portion 24 external to the fuel cell plate 12. As best illustrated in FIG. 3, in one embodiment, a non-conductive fluid seal 26 is disposed around at least a portion of the electrical terminal 20 such that leakage of fluid and gases from within the fuel cell assembly 10 is prevented.

In one embodiment, the first portion 22 of the sealed electrical terminal 20 is in communication with at least one aperture 14 or flow path 16 formed in the fuel cell plate 12. The first portion 22 of the electrical terminal 20 may also connected to a sensing device 40 disposed within the fuel cell assembly 10 for the purpose of sensing internal conditions such as temperature, pressure, electrical flow, fluid flow, or electric field strength. Alternatively, the first portion 22 may also be connected to a control device 42. Under certain circumstances, the control device 42 may be activated to regulate fluid flow by opening or closing apertures 14 and/or flow paths 16 formed in the fuel cell plates 12. The first portion 22 may also be configured as a sensing device 40 thereby eliminating the need for a mechanism to connect to a standalone sensing device 40.

The second portion 24 may be selectively connected to a monitoring device, power supply, or other external circuit (not shown) as necessary for gathering information about internal conditions, for supplying power to sensing or control devices, or for accessing energy being generated by the fuel cell.

The electrical bridge 18 is preferably formed integral to, and of the same material as, the fuel cell plate 12. However, the electrical bridge 18 may be formed of any material capable of withstanding the fuel cell environment. The electrical terminal 20 may be formed of any conductive material capable of withstanding the operating temperatures of the fuel cell assembly 10 and capable of resisting corrosion caused by exposure to the internal and external environments of the fuel cell assembly 10. Preferably, the non-conductive fluid seal 26 is formed of a material that provides the requisite chemical resistance and low modulus necessary to adequately seal fuel cells operating at higher temperatures or employing hydrocarbon-based heat transfer fluids and coolants.

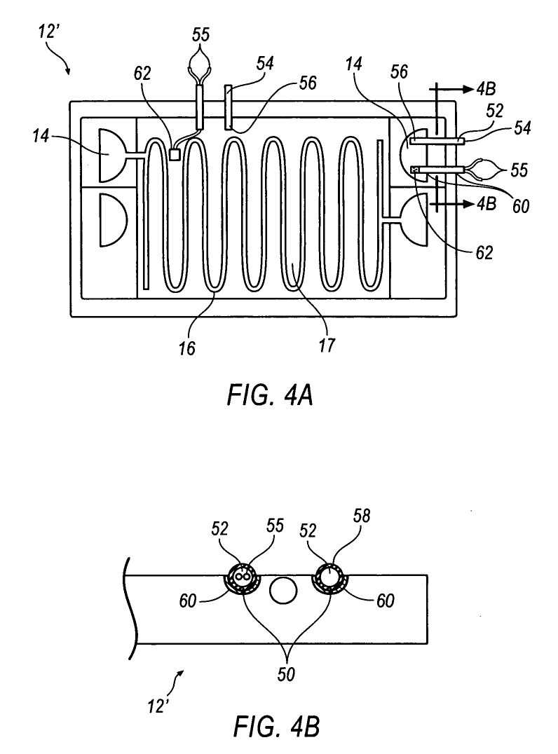

FIGS. 4A-4B illustrate an alternative embodiment of a fuel cell plate 12′. In one exemplary embodiment, fuel cell plate 12′ includes at least one groove or channel 50 that is disposed with a conductive path 52 through a wall of fuel cell plate 12′. Conductive path 52 has a first end 54 that extends external to the fuel cell plate 12′ and a second end 56 that extends into apertures and/or flow paths 14, 16, respectively, of the fuel cell plate 12′. The conductive path 52 may be formed of any material capable of withstanding the operating environment of the fuel cell plate 12′, e.g., various metals or metal alloys. The conductive path 52 may be configured to one or more wires 55 extending from the first end 54 such that an internal parameter, e.g. electrical potential, may be monitored.

Groove 50 may be formed in either of the anode or cathode plates of a fuel assembly or both. In one embodiment, a conductive adhesive coating material 58 is used to bond the conductive path 52 within the groove 50 of the fuel cell plate 12′. The conductive adhesive coating material 58 may be any conductive adhesive coating material 58 capable of withstanding the operating environment of the fuel cell plate 12′. Preferably, the conductive adhesive coating material 58 is disposed on the conductive path 52 prior to the joining of the cathode and anode plates.

As best illustrated in FIG. 4B, fluid seals 60 may be provided proximate both the first 54 and second 56 ends of the conductive path 52 such that fluid leaks are prevented. The conductive path 52 is configured to provide a path for electrical signals to pass between the internal and external environments of the fuel cell assembly 10 whereby internal parameters of the fuel cell assembly 10 can be monitored without creating a leak path therein. The conductive path 52 is preferably electrically connected to, or includes an integrated sensing or control device 62 disposed at the second end 56 thereof for sensing internal parameters of the fuel cell assembly 10.

It is to be understood that the above description is intended to be illustrative and not limiting. Many embodiments will be apparent to those of skill in the art upon reading the above description. Therefore, the scope of the invention should be determined, not with reference to the above description, but instead with reference to the appended claims, along with the full scope of equivalents to which such claims are entitled.

1. A fuel cell assembly comprising:
at least one fuel cell plate; and
at least one electrical bridge connected to said fuel cell plate, said electrical bridge including at least one sealed electrical terminal disposed through said fuel cell plate, said sealed electrical terminal having a first portion extending within said fuel cell plate and a second portion external to said fuel cell plate, and an electrically non-conductive and chemically resistant low modulus fluid seal disposed around said sealed electrical terminal along its entire length within said fuel cell plate, wherein said seal electrically and chemically isolates said sealed electrical terminal from thermal conditions, fluids, and coolants within said fuel cell plate.

2. The assembly of claim 1 wherein said first portion of said electrical terminal is in communication with a flow path or aperture formed in said fuel cell plate.

3. The assembly of claim 2, wherein said fuel cell assembly includes a plurality of fuel cell plates stacked together, each of said fuel cell plates having an aperture formed therein, wherein said apertures of adjacent fuel cell plates align with one another to form a cavity extending through said fuel cell assembly.

4. The assembly of claim 2, wherein said fuel cell plate includes at least one recess extending downwardly from a first surface of said fuel cell plate, said recess defining said flow path.

5. The assembly of claim 1 wherein said first portion is connected to a sensing device.

6. The assembly of claim 1 wherein said first portion is connected to a control device.

7. The assembly of claim 1 wherein said electrical bridge is formed integral to said fuel cell plate.

8. The assembly of claim 1 wherein said at least one electrical bridge is selectively connected to an external monitoring device or power supply.

9. A fuel cell assembly comprising:
a plurality of fuel cell plates stacked together; and
at least one electrical bridge integrally connected to at least one fuel cell plate, said at least one electrical bridge including at least one sealed electrical terminal disposed through said fuel cell plate, said sealed electrical terminal having a first portion extending within said fuel cell plate and a second portion external to said fuel cell plate, and an electrically non-conductive and chemically resistant low modulus fluid seal disposed around said sealed electrical terminal along its entire length within said fuel cell plate, wherein said seal electrically and chemically isolates said sealed electrical terminal from thermal conditions, fluids, and coolants within said fuel cell plate.

10. The assembly of claim 9 wherein said first portion of said electrical terminal is in communication with a flow path or aperture formed in said fuel cell plate.

11. The assembly of claim 10, wherein each of said fuel cell plates has an aperture formed therein, wherein said apertures of adjacent fuel cell plates align with one another to form a cavity extending through said fuel cell assembly when said plurality of fuel cell plates are stacked together.

12. The assembly of claim 10, wherein each of said fuel cell plates includes at least one recess extending downwardly from a first surface of said fuel cell plate, said recesses of adjacent plates cooperating with one another to define said flow path.

13. The assembly of claim 9 wherein said first portion is connected to a control device.

14. The assembly of claim 9 wherein said first portion is connected to a sensing device.

15. The assembly of claim 9 wherein said at least one electrical bridge is selectively connected to an external monitoring device or power supply.

16. A fuel cell assembly comprising:
at least one fuel cell plate configured to receive a conductor disposed through said fuel cell plate, said conductor having an electrically non-conductive and chemically resistant low modulus fluid seal disposed therearound, along the entire length of said conductor within said fuel cell plate, wherein said seal electrically and chemically isolates said conductor from thermal conditions, fluids, and coolants within said fuel cell plate,
and wherein said conductor provides a fluidly sealed conductive path between internal and external environments of the fuel cell assembly, said conductor is connected to a sensing device disposed internal to the fuel cell assembly.

17. The fuel cell assembly of claim 16, wherein said conductor is received within a groove formed through said fuel cell plate.

18. A fuel cell assembly of claim 16 further comprising at least one other conductor that is operatively connected to a control device disposed internal to the fuel cell assembly.

19. The fuel cell assembly of claim 16, wherein said conductor is selectively connected to an external monitoring device.
